(19) United States
(12) Patent Application Publication
(10) Pub. No.: US 2004/0172892 A1
(43) Pub. Date: Sep. 9, 2004

(54) Glass door and/or fixed glass wall construction for refrigerated cabinets

(76) Inventor: Alessandro Cremaschi, Pavia (IT)

Correspondence Address: James V. Costigan, Esq., Hedman & Costigan, P.C., Suite 2003, 1185 Avenue of the Americas, New York, NY, 10036-2646, US

(21) Appl. No.: 10/384,201

(22) Filed: Mar. 7, 2003

(51) Int. Cl. E04C 2/34; E06B 7/00

(52) U.S. Cl. 52/171.3; 52/788.1; 52/786.1

(57) ABSTRACT

A glass door and/or fixed glass wall construction for refrigerated cabinets comprises at least a glass component including chambers filled with an inert gas or mixtures of inert gases.

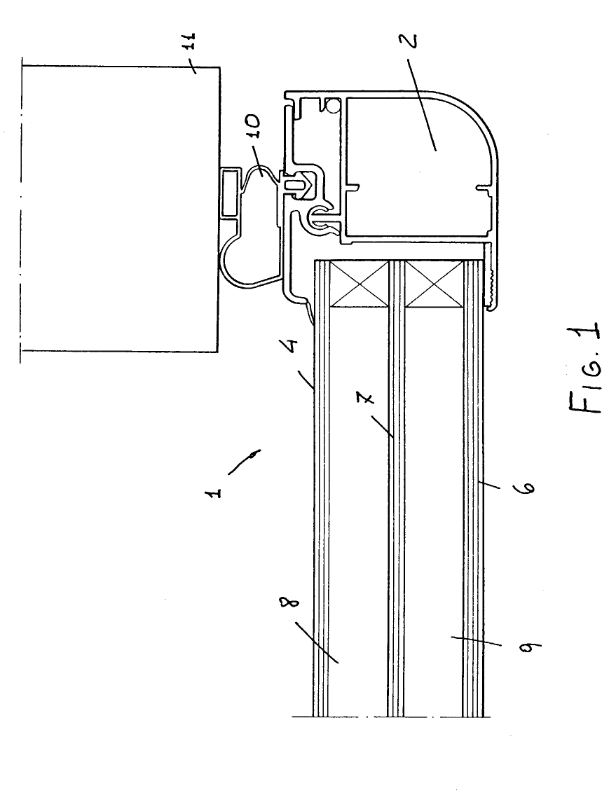

### BACKGROUND OF THE INVENTION

The present invention relates to a glass door and/or fixed glass wall construction for refrigerated cabinets.

As is known, in the refrigerating field are conventionally used several types of glass doors provided for commercial exhibition cabinets, for example for selling refrigerated soft drinks and ice creams in outside environment, industrial cabinets, for preserving food materials in industrial kitchens and the like, scientific cabinets, designed for preserving blood, organic tissues and laboratory chemical composite materials.

The glass doors for the above mentioned applications are exclusively differentiated with respect to some aesthetic features and technically they can be considered as included in two main families, distinguished by the refrigerating inner temperature, which can be either negative, less than or equal to 0° C., or positive, i.e. greater than 0° C.

The so-called “negative” doors, provided for refrigerators having an operating inner temperature less than 0°, are conventionally provided with an electric resistance arranged inside the aluminium and/or plastic frame of the door, and with a glass-chamber of different composition, but always with the outermost plate of conductive and heating nature, which is conventionally heated through an electric power supply, usually with a power density of about 120 W/m².

Both the above mentioned devices are used for preventing steam from condensing on the outer surface of the door, because of the temperature differential between the inner and outer temperature of the refrigerated cabinets.

Actually, a condensate on the door would represent a very objectable phenomenon, to be absolutely prevented, since it would prevent, at first, the refrigerated goods from being easily seen by the consumer, thereby defeating the intended function of the glass material.

Moreover, a condensate would generate safety problems, related to water dispersion on present electric apparatuses.

Another drawback related to the formation of condensate material is that of a bad efficiency exhibition image of the refrigerator.

In this connection it should be pointed out that the door including heated glass plates are expensive components and the makers of negative doors frequently encounter great difficulties to provide such a product.

Moreover, the maker of heating glass materials are also makers of the related doors, and this would represent a great risk with respect to potential competing makers.

### SUMMARY OF THE INVENTION

Accordingly, the aim of the present invention is to provide such a glass door and/or fixed glass wall construction for refrigerated cabinets, which uses alternative glass components, allowing to obtain the same result as that provided by the electrically power supplied glass doors.

Within the scope of the above mentioned aim, a main object of the present invention is to provide such a glass door construction allowing to greatly reduce the power electric consume of the refrigerating cabinets.

Another object of the present invention is to provide such a glass door construction which can be made at a low cost.

Yet a further object of the present invention is to provide such a glass door construction which is very reliable and safe in operation.

According to one aspect of the present invention, the above mentioned aim and objects, as well as yet other objects, which will become more apparent hereinafter, are achieved by a glass door construction, specifically designed for refrigerating cabinets, characterized in that said glass door construction comprises at least a glass component provided with chambers filled with an inert gas or inert gas mixtures.

### BRIEF DESCRIPTION OF THE DRAWINGS

Further characteristics and advantages of the present invention will become more apparent hereinafter from the following disclosure of a preferred, though not exclusive, embodiment of the invention, which has been illustrated, by way of an indicative, but not limitative example, in the accompanying drawings, the sole FIGURE of which is a cross-sectioned top plan view of a portion of the glass door construction according to the invention, shown in the region of the ledge thereof.

### DESCRIPTION OF THE PREFERRED EMBODIMENT

With reference to the number references of the above mentioned FIGURE, the glass door construction, according to the invention, which has been generally indicated by the reference number 1, comprises a bearing framework, preferably constituted by a section member 2, adapted to support a glass component 3 including chambers filled with inert gas mixtures.

The glass component, in particular, is constituted, in the embodiment being illustrated, by three glass panels, respectively an inner glass panel 4, an outer glass panel 6 and a middle glass panel 7 which defines two chambers, respectively indicated by the reference numbers 8 and 9, which are filled with an inert gas or a mixture of inert gases.

The inert gases to be used are, for example, noble gases, or rare gases, such as krypton, argon and xenon, according to the requirements and the commercial availability thereof.

Advantageously, the chambers are sealed and filled with a room pressure gas, thereby preventing outside air from entering said chambers, while preventing the inert gases from exiting the chambers.

The door construction comprises the conventional attaching system for attaching or latching the door to the walls of the cabinets, said latching or attaching systems comprising hinge assemblies, not specifically shown, a magnetic type of gasket 10, coupled to the section member 2, and adapted to abut against the wall 11 of the cabinet, in a per se known manner.

The door construction, provided with the above disclosed specifically designed glass component, with chambers filled with inert gas mixtures and not electrically powered, has been tested, according to the average parameters required by the end users, and it has been found as fully efficient.

In this connection it should pointed out that the glass door construction according to the invention can be easily applied to exhibition cabinets comprising either one or more clear side walls.

These side walls can be advantageously constructed to have the same construction of the glass door according to the invention, with the sole difference that said walls would not be openable.

Thus, also the construction of the above mentioned glass walls constitutes an integrating part of the present invention.

It has been found that the invention fully achieves the intended aim and objects.

In fact, the invention provides a glass door and/or glass wall construction, specifically designed for refrigerating cabinets, which does not uses the conventional heating glass plates, while allowing to achieve the same result as the electrically power supplied glass doors.

Actually, an important advantage of the invention is the elimination of the glass power supply, with a consequent increase of the safety of the product and a great reduction of the power consume.

Moreover, since the glass door and/or glass walls can be made in a very simple manner, the invention further provides the great advantage of greatly reducing the making cost.

In practicing the invention, the used materials, provided that they are compatible to the intended application, as well as the contingent size and shapes of the constructional elements, can be any, depending on requirements.

1. A glass door construction, specifically designed for refrigerating cabinets, characterized in that said glass door construction comprises at least a glass component including chambers filled with an inert gas or inert gas mixtures.

2. A glass door construction, according to claim 1, characterized in that the glass component comprises two glass panels defining at least a sealed chamber containing said inert gas or inert gas mixtures.

3. A glass door construction, according to claim 1, characterized in that the glass component comprises three glass panels, respectively an inner glass panel, an outer glass panel and a middle glass panel, adapted to define two chambers filled with said inert gas or inert gas mixtures.

4. A glass door construction, according to claim 1, characterized in that said inert gas is selected from krypton, argon and/or xenon.

5. A glass door construction, according to claim 1, characterized in that said chambers are sealed and filled with room pressure inert gases, thereby preventing outside air from entering said chambers while preventing said inert gas from exiting said chamber.

6. A glass door construction specifically designed for refrigerating cabinets, according to claim 1, characterized in that said glass door construction can be applied to an exhibition cabinet comprising one or more fixed clear side walls having the same structure as said glass door construction.
